(19) United States
(12) Patent Application Publication
(10) Pub. No.: US 2019/0254457 A1
(43) Pub. Date: Aug. 22, 2019

(54) Clamp for headwear and other objects

(71) Applicant: Raoul East Drapeau, Ashburn, VA (US)

(72) Inventor: Raoul East Drapeau, Ashburn, VA (US)

(21) Appl. No.: 15/898,281

(22) Filed: Feb. 16, 2018

(51) Int. Cl. A47G 25/10; F16B 2/10; F16B 1/04

(52) U.S. Cl. CPC A47G 25/10; F16B 2001/0021; F16B 1/04; F16B 2/10

(57) ABSTRACT

A clamp for headwear and other objects. The clamp includes a movable arm pivotably coupled to a fixed arm, which is coupleable to a surface. An object can be inserted into the gap between the lower ends of the two arms. A spreader element in an extended position maintains the lower ends of the arms spread apart. A spring exerts a force on the upper ends of the arms so as to push the lower ends of the arms together. Insertion of an object into the gap moves the spreader into a withdrawn position, allowing the lower ends of the arms to grip the object. Pushing the upper ends of the arms together releases the object and replaces the spreader element in the extended position.

### FIELD OF THE INVENTION

This invention relates to an improvement in holders for storing headwear with brims.

### DESCRIPTION OF RELATED ART

Much of the prior art in the field of cap and hat storage has been apparatuses that hold several hats, into which the brim, crown, top, rear or other parts of the hat or cap are inserted or placed (e.g., U.S. Pat. Nos. 5,137,157, 5,727,694, 5,480,073, 5,921,403, 5,240,123, 5,092,472, and 6,293,413). Other art uses a spring-loaded clasp into which the brim is inserted while holding the jaws open and then released by repeating the same process (e.g., U.S. Pat. Nos. 831,627, 1,570,451, and 1,491,286). And yet in another type, the brim is inserted by pushing it into the spring-loaded jaws and then released by pulling it out (e.g., U.S. Pat. Nos. 1,160,769 and 5,074,508). This prior art is either bulky, unappealing in appearance, ineffective, inconvenient or difficult to operate.

### BACKGROUND

For persons who wear hats, storing them in a convenient, accessible place is a common problem. Typically, in the home, the hats are placed or stacked on a closet shelf, which makes them neither convenient nor easily accessible. While hat-holding devices are known in the art, none provide a practical, simple means of gripping the bill or brim and then releasing it. Moreover, many of the prior art devices are bulky, unsightly, and not modular. Moreover, many of the prior art devices are large structures intended to hold multiple hats of the same kind and used for display or team use.

Embodiments of the current invention are much more flexible in the type of hat that they can hold, as well as their ease of use and mounting method, and thus are particularly useful in the home or office. The current invention solves the aforementioned problems by providing a clamp having spring-loaded arms that can be mounted, for example, on the inside surface of a door, such on a closet, or on any flat surface. Depending on the number and size of hats, the number of clamps mounted and their spacing can be any convenient or desired pattern. In addition, the design of the current invention is such that it makes the process of inserting and removal of the hat much easier and more convenient than that of the prior art. By applying the clamp to the back of a closet door, for example, the space between the door and the clothes that otherwise would be wasted can now be used for hat storage. Furthermore, the clamps can be mounted at any convenient height, allowing hats to be stored within reach, rather than on a shelf, which is often too high to be easily accessible.

### SUMMARY

Embodiments of the current invention disclose an improved clamp for storing hats. The clamp includes a fixed arm and a movable arm, a shaft that acts as an axis about which the arms can pivot, and a spring that forces a pair of lower ends of the two arms to abut each other. On the upper portion of the movable arm, above the pivot axis, is an area that is pushed by the user to release a hat brim held by the lower ends.

The clamp can be coupled to a surface by mounting means such as one or more adhesive pads on the outside surface of the fixed arm, or, alternatively, one or more screws passing through that arm and into the mounting surface. A spreader element disposed between the arms, having one end hingedly coupled to the lower part of one of the arms and another end resting on a stop on the other arm, serves to hold the lower ends of both arms apart and open.

As the user inserts the brim of a hat to be held into the gap between the lower arms of the clamp, the brim contacts and pushes upwards the spreader element. Because of the upward force provided by the hat brim, the free end of the spreader swings upward, causing the spring to exert its force to quickly close the lower ends onto the brim. This action takes a minimum insertion force, yet the brim will be held tightly by the lower ends of the arms. Removal of the hat requires pushing the upper part of the movable arm of the clamp, thereby releasing the brim and resetting the lower ends into an open position for the next use, while the hat falls out of the clamp by force of gravity. In some embodiments, a spring may be coupled to the spreader, thereby adding force to the spreader to urge it into the extended position.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a front view of the clamp, showing outer surface of the movable arm having a soft pad for finger pressure.

FIG. 2 is a rear view of the clamp, showing the outer surface of the fixed arm having adhesive pads for fastening the clamp to a mounting surface.

FIG. 3 is a side view of the clamp showing gripping pads, adhesive pads, spreader, spreader stop and compression spring.

FIG. 4 is a cross-sectional view of the clamp along line A-A of FIG. 3.

FIG. 5 is a rear view of the movable arm, showing the inside surface of the movable arm, a compression spring, two pivoting axes, a grip pad, and a spreader.

FIG. 6 is a side view of another exemplary embodiment of the clamp, wherein the resilient member is a torsional spring.

FIG. 7 is a side view of another exemplary embodiment of the clamp, wherein the lower ends of the arms are covered by caps formed from a soft material, and further including a torsion spring engaging the spreader.

FIG. 8 shows the clamp in a fully open configuration, with a brim being inserted into the gap between the lower ends of the arms.

FIG. 9 shows the brim pushing aside the spreader, thereby placing the clamp in a fully closed configuration, wherein the lower ends of the arms grip the brim.

FIG. 10 shows a finger depressing the movable arm, thereby compressing the spring, releasing the brim and causing the spreader to drop towards a stop.

FIG. 11 shows a finger withdrawing contact, leaving the clamp in a fully open configuration.

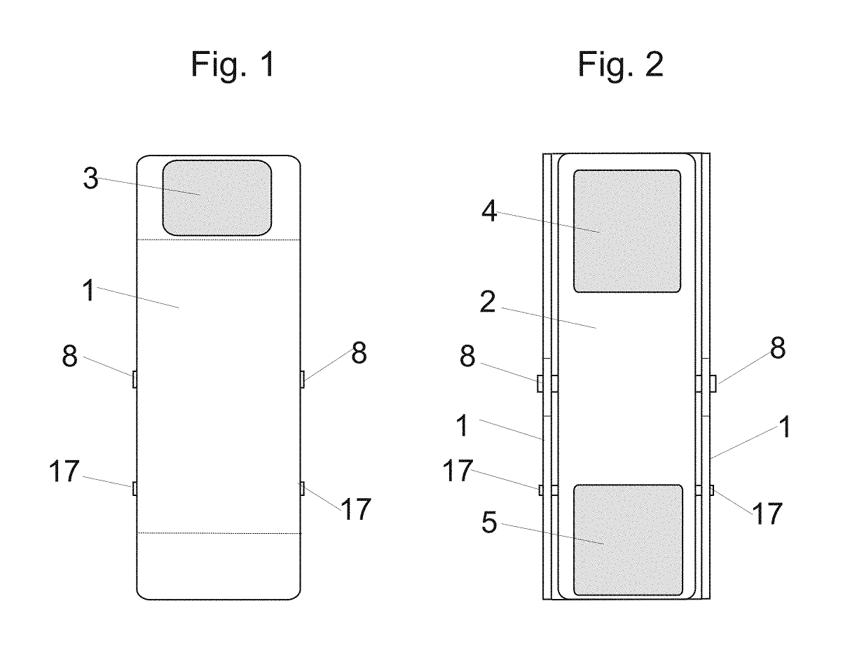

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to one exemplary embodiment, and as shown in the Figures, a hat-retaining clamp is disclosed. The clamp includes a pair of arms, a movable arm 1 and a fixed arm 2, arranged in front-to-rear relation, with their inner surfaces facing each other. The arms 1 and 2 are pivotably coupled by a hinge 8, pivoting about the longitudinal axis of hinge 8. The fixed arm 2 may be coupled to any surface, for example a closet door or a wall, by any desired means, such as, for example, mounting pads 4 and 5. The mounting pads can be secured to fixed arm 2 by an adhesive, while the outward-facing surface of the mounting pads can also include an adhesive, which is covered by a release liner until ready for use. At that time, the liner is removed and the clamp can be pressed into place on a mounting surface. Alternatively, the clamp can be mounted on screws that are received in corresponding keyhole slits (not shown) defined in fixed arm 2. The surface to which the clamp is mounted may be a vertical surface, an angled surface, or otherwise oriented in any direction that enables the clamp to function as described herein.

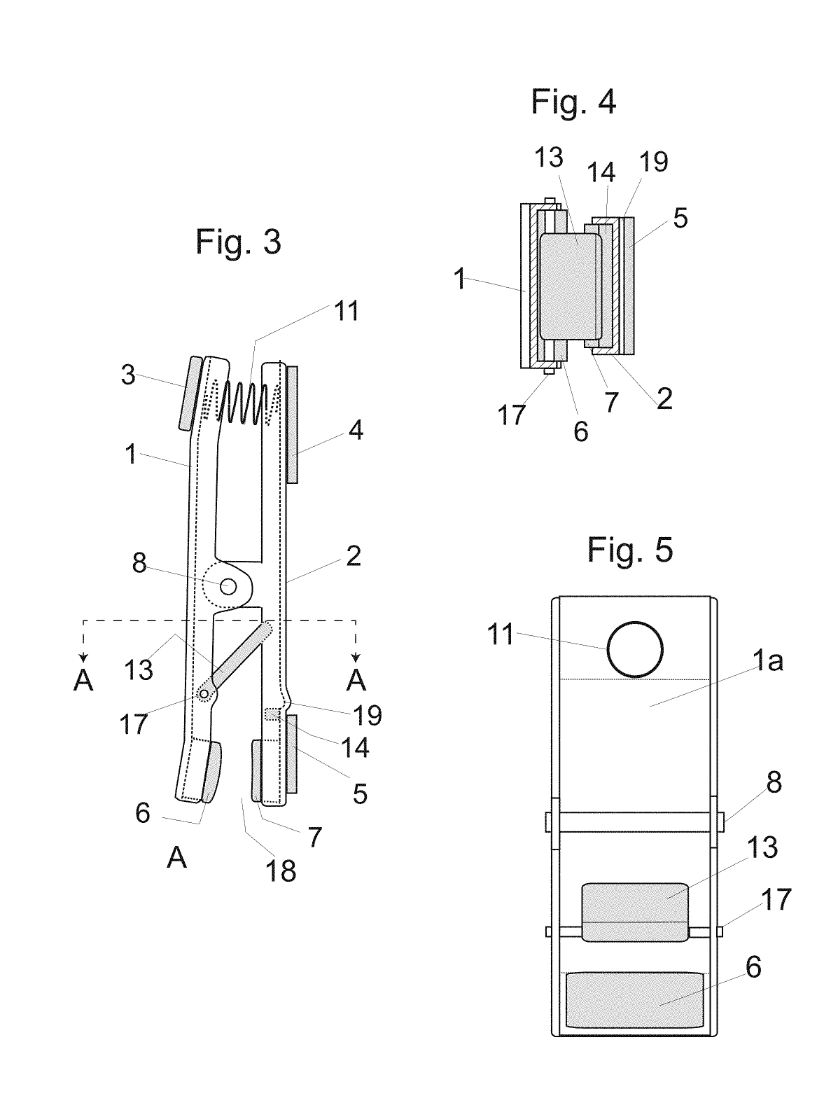

FIG. 3 is a side view of the clamp in a partially open configuration. Such a configuration would not occur statically in normal operation, but is shown here for clarity in the relationship of the component parts. A resilient member, for example compression spring 11, applies force to spread the upper ends of arms 1, 2 apart, thereby closing the lower ends of arms 1, 2 as the arms pivot about hinge 8. The lower end of movable arm 1 has a pad 6, which may be convex, while the lower end of fixed arm 2 has a pad 7, which may be concave. Pads 6 and 7 are gripping members that serve to grip the brim of a hat while also providing some protection and cushioning to the hat brim surface. The gap 18 between the lower ends of arms 1, 2 provides the space for insertion of the brim.

A spreader 13, shown here in an intermediate position, may be a rod, a flap, or the like, and is pivotably coupled to movable arm 1 via pivot 17. A first end of spreader 13 is coupled to hinge 17, while the opposite end of spreader 13 is free and influenced by gravity, such that when it is not constrained, the spreader pivots towards a stop 14. Stop 14 is disposed on the inner surface of fixed arm 2. The distance between hinge 8 and stop 14 may be slightly greater than the distance between hinge 8 and pivot 17. Optionally, a groove 19 extends transversely across fixed arm 2 and is disposed proximate stop 14. While in this embodiment, spreader 13 is coupled to movable arm 1 while stop 14 and groove 19 are at fixed arm 2, the location of these elements could be switched between the two arms without detracting from the functionality of the clamp. Alternatively, stop 14 and spreader 13 may be positioned on the same arm, such that, when stop 14 engages spreader 13, the free end of spreader 13 is disposed slightly below pivot 17.

In some embodiments, the upper and lower ends of movable arm 1 may be angled with respect to the central portion of arm 1. The upper end of movable arm 1 may be angled towards fixed arm 2, so as to provide a more convenient range of movement for the user's finger as it depresses the upper end of arm 1. The lower end of movable arm 1 may be angled away from fixed arm 2, such that when the clamp is in a closed configuration, the lower end of movable arm 1 is substantially parallel to, or almost parallel to, the lower end of fixed arm 2. Such a configuration allows for greater surface contact between the gripping pads and the hat brim, thereby increasing the clamping force on the hat brim. An exemplary range of the angles between the ends of arm 1 and the central portion of arm 1 may be approximately 0°-10°, but would depend on the geometry of the particular implementation of the embodiments disclosed herein.

FIG. 4 is the cross-sectional view of arms 1, 2 along line A-A of FIG. 3. While the dimensions shown are such that the two arms could nest within one another when closed, the operation is such that such a condition does not occur. Both arms could have the same width, however, if the portion where the arms are joined at hinge 8 were adjusted to prevent interference between the arms. While the arms are both shown here with slight flanges to provide strength against bending, the need for the flanges, as well as the dimensions thereof, will depend on the material used.

FIG. 5 shows a rear view of movable arm 1, showing the interior surface thereof. Seen here are the interior surface 1a, compression spring 11, hinge 8, pad 6, and spreader 13 with its pivot 17.

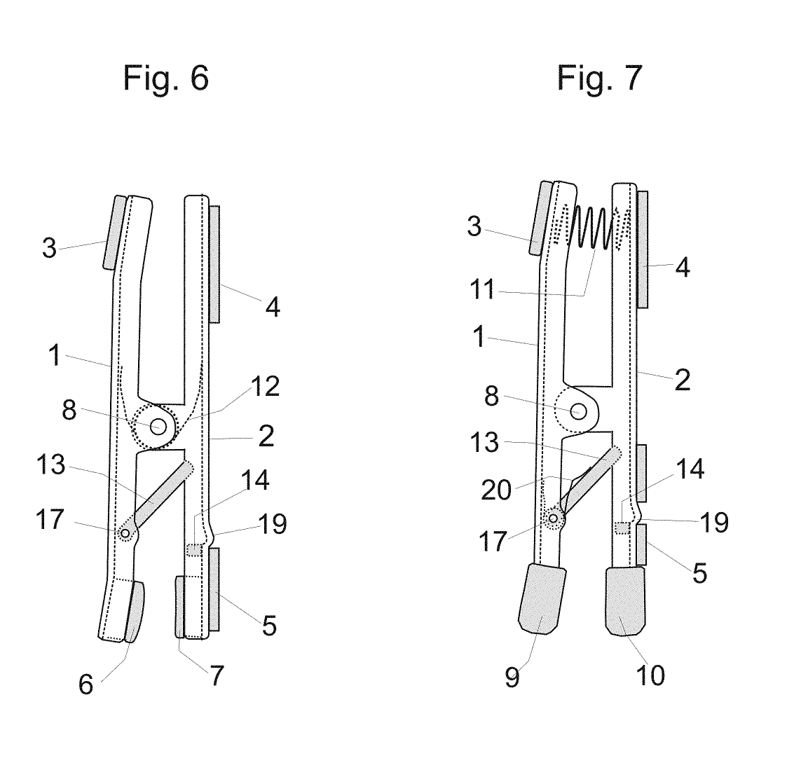

FIG. 6 shows an alternate embodiment of the clamp shown in FIG. 3. In this alternate embodiment, the resilient member is a torsional spring 12 instead of compression spring 11. Both types of spring can serve the same purpose, which is to keep the upper ends of arms 1, 2 spaced apart and the lower ends of arms 1, 2 gripping the brim of an inserted cap or hat. Any other kind of resilient member that allows the clamp to function as described herein may also be used and positioned accordingly.

FIG. 7 shows another alternate embodiment of the clamp. wherein the gripping members are soft caps 9 and 10 that cover the ends on the lower ends of arms 1 and 2, respectively. These caps are typically produced by dipping the ends of the arms in a liquid compound and likewise serve to grip and help prevent damage to the brim. Any other gripping members that allow the clamp to function as described herein may be contemplated and provided as desired. FIG. 7 further shows a second resilient member, for example a torsion spring 20, engaging the spreader 13 so as to impart a downward force to spreader 13. This can provide additional force to move the spreader into the extended position, which may be useful if the clamp is mounted on a non-vertical surface. It should be understood that this second resilient member may be used with any embodiments of the clamp described herein.

The next four figures show a sequence of operation.

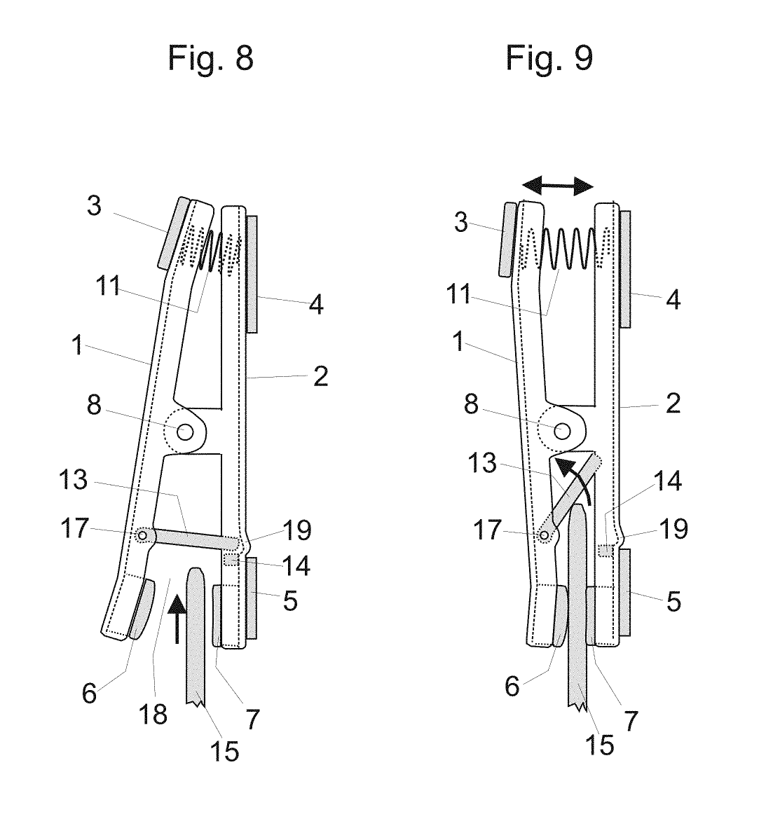

FIG. 8 depicts a side view of the clamp an open configuration, with a hat brim 15 being inserted into the gap 18 between pads 6 and 7. The spring 11 is fully compressed and thus providing its greatest force urging the top of both arms to separate. However, the jaws are prevented from closing by spreader 13, which is disposed in an extended position and is pressing against the inside surface of fixed arm 2 while resting on the stop 14. In the extended position, the free end of spreader 13 can also abut groove 19 of fixed arm 2, with the groove providing a detent on the inner surface of the fixed arm, imparting additional stability to spreader 13 in this position.

FIG. 9 shows the clamp in a closed configuration. The inserted brim 15 has pushed spreader 13 upwards, placing the spreader in a withdrawn position and thereby allowing the lower ends of the arms to close on the brim. The brim is held securely by pads 6, 7 due to the force exerted by spring 11 on the upper ends of the inner surfaces of arms 1, 2. A smoother and less resistant motion of the spreader 13 may be facilitated by a low-friction material disposed on the inside surface of fixed arm 2, on the free end of the spreader, or both. Alternatively, the spreader itself may be formed from a low-friction material.

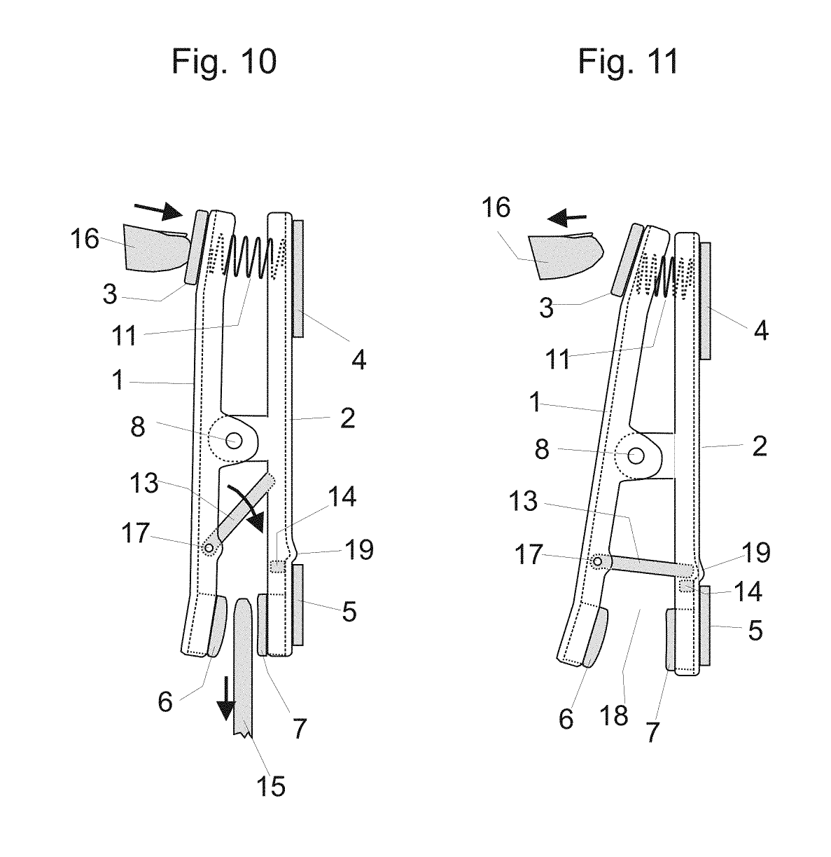

FIG. 10 illustrates a configuration of the clamp when a user's finger 16 pushes on pad 3 of movable arm 1, thereby compressing spring 11 and opening the lower ends of the arms. The brim 15 is released and can drop out under the weight of the hat. Furthermore, spreader 13 drops under the effect of gravity, or of spring 20, to engage stop 14, which prevents further downward travel of the free end of the spreader.

FIG. 11 depicts the clamp in the open configuration, when the finger is withdrawn completely. The lower ends of the arms are now completely open, and held open by spreader 13 being in the extended position and engaging the inside surface of fixed arm 2. It should be noted that the positioning of stop 14 may be below axis 17. Consequently, the distal end of the spreader 13 is below its pivoting axis 17, thereby producing a downward force on the spreader and stabilizing the open configuration.

Variations to the design of the described embodiments, with respect to dimensions, shape, arm travel distance, spring type, arrangement of elements, and so forth, may be contemplated and provided as desired without departing from the scope and spirit of the invention. For example, in some embodiments, the spreader may be provided as a hinged member pivotably coupled to both arms, with a hinge therebetween. In the extended position, the spreader hinge may be disposed slightly below the pivots, spreading the lower ends of the arms apart. In the withdrawn position, the spreader hinge may be disposed above the pivots, allowing the lower ends of the arms to be brought together. Furthermore, while the embodiments disclosed herein are described as being used with brimmed hats, it should be understood that the invention may be used with any type of object, including apparel and non-apparel items, that allows the invention to function as described herein.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A clamp, comprising:
a fixed arm coupleable to a surface, and having an upper end and a lower end;
a movable arm, pivotably coupled to the fixed arm, and having an upper end and a lower end;
a resilient member exerting a separating force on the upper ends of the fixed arm and the moveable arm;
a spreader, disposed between the fixed arm and the movable arm, the spreader being movable between an extended position and a withdrawn position;
a stop positioned such that, when the spreader engages the stop, movement of the movable arm is impeded.

2. The clamp of claim 1, wherein the lower end of the moveable arm and the lower end of the static arm are adapted to engage and maintain an object therebetween.

3. The clamp of claim 1, wherein the spreader includes a first end pivotably coupled to one of the fixed arm or the movable arm, and a free end opposite the first end;

4. The clamp of claim 3, further comprising a detent positioned to engage the free end of the spreader, when the spreader engages the stop.

5. The clamp of claim 1, wherein one or both of the upper end of the movable arm and the lower end of the movable arm is angled with respect to the central portion of the arm.

6. The clamp of claim 1, wherein the lower end of the movable arm and the lower end of the static arm include gripping members positioned to engage and maintain an object therebetween.

7. The claim of claim 1, further including a low friction material provided for one or more of: the inner surface of an arm, said inner surface contacting the free end of the spreader, the free end of the spreader, or the body of the spreader.

8. A clamp, comprising:
a fixed arm coupleable to a surface, and having an upper end and a lower end;
a movable arm, pivotably coupled to the fixed arm, and having an upper end and a lower end;
a spreader disposed between the fixed arm and the movable arm, the spreader being movable between an extended position and a withdrawn position;
wherein, when the spreader is in an extended position, a gap is defined between the lower end of the fixed arm and the lower end of the moveable arm; and
wherein, upon insertion of an object into the gap, the spreader is moved into a withdrawn position by the object, thereby allowing the lower end of the movable arm to move towards the lower end of the fixed arm and to engage the object therebetween.

9. The clamp of claim 8, wherein, when the spreader is in the extended position, the movement of the movable arm is impeded until the spreader is moved out of the extended position.

10. The clamp of claim 8, further comprising a resilient member exerting a force on the movable arm such that, when movement of the movable arm is unimpeded, the lower end of the movable arm moves towards the lower end of the fixed arm.

11. The clamp of claim 8, wherein the spreader comprises a first end pivotably coupled to one of the fixed arm or the moveable arm and a free end opposite the first end.

12. The clamp of claim 11, wherein, when the spreader is in the extended position, the free end is disposed below the first end.

13. The clamp of claim 8, further comprising a resilient member adapted to exert a force on the spreader so as to move the spreader into the extended position.

14. A clamp adapted to alternate between an open configuration and a closed configuration, comprising:
a pair of arms pivotably coupled to each other, each arm having an upper end and a lower end;
a spreader disposed between the pair of arms and movable between an extended position and a withdrawn position; and
a resilient member exerting a force to place the clamp into the closed configuration;
wherein, in the open configuration, the spreader is in an extended position and prevents the clamp from being placed into the closed configuration; and
wherein, in the closed configuration, the spreader is in a withdrawn position and the lower ends of the arms engage and maintain an object therebetween.

15. The clamp of claim 14, wherein the pair of arms further comprises a movable arm and a fixed arm coupleable to a surface.

16. The clamp of claim 14, wherein the spreader comprises a first end pivotably coupled to one arm of the pair of arms and a free end opposite the first end.

17. The clamp of claim 16, wherein, when the spreader is in the extended position, the free end is disposed below the first end.

18. The clamp of claim 14, wherein the spreader is moved from the extended position to the withdrawn position by the object.

19. The clamp of claim 14, further comprising a resilient member adapted to exert a force on the spreader so as to move the spreader into the extended position.
The clamp of claim 14, wherein moving the upper ends of the arms closer to each other places the clamp from a closed configuration to an open configuration.
